(19) United States
(12) Patent Application Publication
(10) Pub. No.: US 2006/0130451 A1
(43) Pub. Date: Jun. 22, 2006

(54) Impregnated filter element, and methods

(76) Inventors: Lefei Ding, Falcon Heights, MN (US); Andrew James Dallas, Apple Valley, MN (US); Jon Dennis Joriman, Little Canada, MN (US)

Correspondence Address: MERCHANT & GOULD PC, P.O. BOX 2903, MINNEAPOLIS, MN, 55402-0903, US

(21) Appl. No.: 11/016,013

(22) Filed: Dec. 17, 2004

(51) Int. Cl. B01D 39/14; B01D 50/00

(52) U.S. Cl. 55/524; 422/177; 55/527; 55/528

(57) ABSTRACT

A contaminant-removal filter for removing carbonyl-containing compounds from a gas stream, such as air. Examples of common airborne carbonyl-containing compounds include ketones, including acetone, and aldehydes, including formaldehyde. The filter has a porous or fibrous body that includes a plurality of passages extending from a first, inlet face to a second, outlet face, the passages providing flow paths. The body has a reactant material impregnated throughout the substrate. The reactant material is a sulfite, bisulfite, oxidant, or derivative of ammonia, specifically high molecular weight and stable amines. Strong alkali (basic) materials are particularly suitable for aldehyde removal. The filter is free of any humectants.

### FIELD

The present invention relates to a low pressure-drop filter element for removing contaminants from a gas stream, such as an air stream. More particularly, the invention relates to removal of carbonyl-containing compounds from a gas stream, by using a fibrous, impregnated filter element.

### BACKGROUND

Gas adsorption articles, often referred to as elements or filters, are used in many industries to remove airborne contaminants to protect people, the environment, and often, a critical manufacturing process or the products that are manufactured by the process. A specific example of an application for gas adsorption articles is the semiconductor industry where products are manufactured in an ultra-clean environment, commonly known in the industry as a “clean room”. Gas adsorption articles are also used in many non-industrial applications. For example, gas adsorption articles are often present in air movement systems in both commercial and residential buildings, for providing the inhabitants with cleaner breathing air.

Typical airborne contaminants include basic contaminants, such as ammonia, organic amines, and N-methyl-2-pyrrolidone, acidic contaminants, such as hydrogen sulfide, hydrogen chloride, or sulfur dioxide, oxides of nitrogen, and general organic material contaminants, often referred to as VOCs (volatile organic compounds) such as reactive monomer or unreactive solvent. Silicon containing materials, such as silanes, siloxanes, silanols, and silazanes can be particularly detrimental contaminants for some applications. Additionally, many toxic industrial chemicals and chemical warfare agents must be removed from breathing air.

The dirty or contaminated air is often drawn through a granular adsorption bed assembly or a packed bed assembly. Such beds have a frame and an adsorption medium, such as activated carbon, retained within the frame. The adsorption medium adsorbs or chemically reacts with the gaseous contaminants from the airflow and allows clean air to be returned to the environment. The removal efficiency and the length of time at a specific removal efficiency are critical in order to adequately protect the processes and the products for extended periods.

The removal efficiency and capacity of the gaseous adsorption bed is dependent upon a number of factors, such as the air velocity through the adsorption bed, the depth of the bed, the type and amount of the adsorption medium being used, and the activity level and rate of adsorption of the adsorption medium. It is also important that for the efficiency to be increased or maximized, any air leaking through voids between the tightly packed adsorption bed granules and the frame should be reduced to the point of being eliminated. Examples of granular adsorption beds include those taught in U.S. Pat. No. 5,290,245 (Osendorf et al.), U.S. Pat. No. 5,964,927 (Graham et al.) and U.S. Pat. No. 6,113,674 (Graham et al.). These tightly packed beds result in a torturous path for air flowing through the bed.

However, as a result of the tightly packed beds, a significant pressure loss is incurred. Current solutions for minimizing pressure loss include decreasing air velocity through the bed by increased bed area. This can be done by an increase in bed size, forming the beds into V's, or pleating. Unfortunately, these methods do not adequately address the pressure loss issue, however, and can create an additional problem of non-uniform flow velocities exiting the bed.

Although the above identified packed bed contaminant removal systems are sufficient in some applications, what is needed is an alternate product that can effectively remove contaminants such as acids, bases, or other organic materials, while minimizing pressure loss and providing uniform flow velocities exiting the filter.

One example of a non-packed bed adsorbent article is disclosed in U.S. Pat. No. 6,645,271 (Seguin et al.). The articles described in this patent have a substrate having passages therethrough, the surfaces of the passages coated or covered with an adsorbent material. The adsorbent material can be held onto the substrate by a polymeric material.

U.S. Pat. No. 6,071,479 (Marra et al.) has attempted to provide a suitable article for removal of contaminants from a gas stream, however, various disadvantages and undesirable features are inherent in the article of Marra et al. For example, the media is not designed for long-term and/or high purity filtration applications. In accordance with the invention of Marra et al., paper media impregnated with base, and a humectant and/or urea is supposedly a suitable contaminant removal article; however, when in actual use, such a product does not provide acceptable performance. Marra et al. include a humectant or an organic amine in order to increase the water content of the adsorptive material, supposedly to aid in the reaction between the basic impregnant and acidic materials to be removed. Additionally, Marra et al. uses binders and glues to retain the structure of the formed media. Such adhesive materials are known to off-gas contaminants, some of which react with or bind with the contaminant-removal material, thus decreasing the amount available for removing contaminants from the gas flowing therethrough.

Better contaminant removal systems are needed, particularly, for carbonyl-containing compounds, which are especially malodorous and toxic.

### SUMMARY OF THE DISCLOSURE

The present invention is directed to a contaminant-removal filter for removal of carbonyl-containing compounds, which includes ketones and aldehydes. The filter includes a substrate having reactive material or reactant present therein and thereon, the reactive material being a sulfite, bisulfite, oxidant, or derivative of ammonia, specifically high molecular weight and stable amines. Strong alkali (basic) materials are particularly suitable for aldehyde removal.

An example of a preferred material for removing carbonyl-containing compounds is activated carbon, such as in granular or particulate form, impregnated with a reactant such as a sulfite, bisulfite, oxidant, or derivative of ammonia, specifically high molecular weight and stable amines. Activated carbon granules or particulate impregnated with strong alkali is specifically suitable for aldehydes removal.

The substrate forming the filter is a fibrous or porous material, such as cellulosic or polymeric material, or a combination thereof. The body of the filter, formed by the substrate, is preferably configured with a plurality of passages extending from an inlet face to an outlet face, the passages providing a pathway for gas flow therethrough.

Present at least on the surface of the substrate, and preferably within the substrate, is the reactant material. The reactant material reacts with or otherwise removes carbonyl-containing contaminants from air or other gaseous fluid that contacts the filter.

The contaminant-removal filter of the present invention can be used in a variety of high purity applications that desire the removal of carbonyl-containing compounds from a gas stream, such as an air stream. By use of the term “high purity” and modifications thereof, what is meant is a contaminant level, in the cleansed gas stream, of less than 1 ppm of contaminant. In many applications, the level desired is less than 1 ppb of contaminant. The contaminant-removal filter of the present invention is a “high purity element” or includes “high purity media”. In this application, such terms refer to materials that not only remove contaminants from the air stream but also do not diffuse or release any contaminants. Examples of materials that are generally not present in high purity elements or high purity media include adhesives or other polymeric materials that off-gas.

The contaminant-removal filter of the invention can be used in a variety of applications. Preferred applications include those where environmental air or other air is cleansed for the benefit of those breathing the air. Often, these areas are enclosed spaces, such as residential, industrial or commercial spaces, airplane cabins, and automobile cabins. The filter can alternately be used in applications such as lithographic processes, semiconductor processing, and photographic and thermal ablative imaging processes. The filter can also be used in engine or power generating equipment, including fuel cells, that uses an air intake source for the combustion process.

In one particular aspect, the invention is to a contaminant-removal filter element comprising a fibrous substrate and a reactant present preferably throughout the substrate. The reactant is a sulfite, bisulfite, oxidant, or derivative of ammonia, specifically high molecular weight and stable amines.

In another particular aspect, the invention is to a contaminant-removal filter element comprising a fibrous substrate having a first face defining an inlet, a second face defining an outlet, and a plurality of passages extending from the first face to the second face. Reactant material is preferably throughout the substrate.

In yet another aspect, the invention is directed to a method of making a contaminant-removal filter, the method comprising applying a mixture or solution of reactant material to a substrate. Typically, the mixture or solution is applied by impregnation.

### BRIEF DESCRIPTION OF THE DRAWINGS

Referring now to the drawings, wherein like reference numerals and letters indicate corresponding structure throughout the several views:

FIG. 1 is a schematic, perspective view of one embodiment of a contaminant-removal filter according to the present invention;

FIG. 2 is a schematic, perspective view of a second embodiment of a contaminant-removal filter according to the present invention;

FIG. 3 is a schematic, perspective view of a third embodiment of a contaminant-removal filter according to the present invention;

FIG. 4 is a schematic, perspective view of a fourth embodiment of a contaminant-removal filter according to the present invention;

FIG. 5 is a schematic depiction of a system incorporating multiple contaminant-removal filters according to the present invention, in conjunction with a particulate filter;

FIG. 6 is a schematic, perspective view of a fifth embodiment of a contaminant-removal filter according to the present invention; and

FIG. 7 is a graphical representation of the results from testing Example 1 and Comparative Example A.

### DETAILED DESCRIPTION

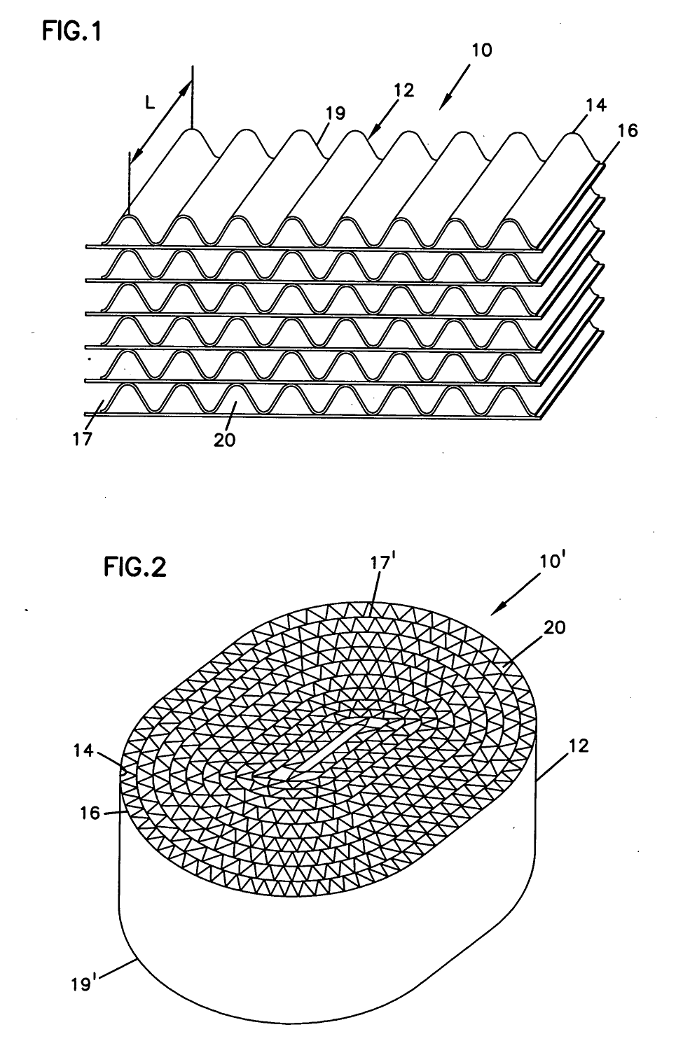

Referring now to the Figures, specifically to FIG. 1, a first embodiment of a contaminant-removal filter or element according to the present invention is shown at 10. Contaminant-removal filter 10 is defined by a body 12 having a first face 17 and an opposite second face 19. Generally, gas to be cleansed of carbonyl-containing compounds enters filter 10 via first face 17 and exits via second face 19. In this embodiment, body 12 is formed by alternating a corrugated layer 14 with a facing layer 16. Corrugated sheet 14 has a rounded wave formation, with each of the valleys and peaks being generally the same. Facing layer 16 can be a corrugated layer or a non-corrugated (e.g., flat) sheet; in this embodiment facing layer 16 is a flat sheet. Layer 14 and layer 16 together define a plurality of passages 20 through body 12 that extend from first face 17 to second face 19. Filter 10 has “straight-through flow” or “in-line flow”, meaning that gas to be filtered enters in one direction through first face 17 and exits in generally the same direction from second face 19. The length of passages 20, “L”, is measured between first face 17 and second face 19; this dimension L generally also defines the thickness of body 12 and of filter 10, in the direction of airflow.

A second embodiment of a contaminant-removal filter according to the present invention is shown at 10′ in FIG. 2. Similar to the article of FIG. 1, contaminant-removal filter 10 is defined by a body 12′ having a first face 17′ and an opposite second face 19′. The distance between first face 17′ and second face 19′ is the thickness of filter 10′. Body 12′ is formed by alternating a corrugated layer 14′ with a facing layer 16′. Corrugated sheet 14′ has an angular wave formation, with each of the valleys and peaks being generally the same height. Facing layer 16′ can be a corrugated layer or a non-corrugated (e.g., flat) sheet; in this embodiment facing layer 16′ is a flat sheet. Layer 14′ and layer 16′ together define a plurality of passages 20′ through body 12′ that extend from first face 17′ to second face 19′.

Body 12 of FIG. 1 and body 12′ of FIG. 2 have a similar construction in that they both include a corrugated layer 14, 14′ and a facing layer 16, 16′. For body 12, two layers 14, 16 are alternatingly stacked, providing a generally planar filter 10. For body 12′, two layers 14′, 16′are alternatingly coiled, providing a generally cylindrical filter 10′. Filter 10′ illustrated has a non-circular cross-section, such as an oval, elliptical, or racetrack shape; other shapes, particularly a circle, could also be formed by coiling layers 14′, 16′. Additionally, a shape having two parallel sides, two other parallel sides orthogonal to the first two parallel sides, and four rounded corners therebetween, could also be coiled. Any coiled construction could include a central core to facilitate winding of the layers.

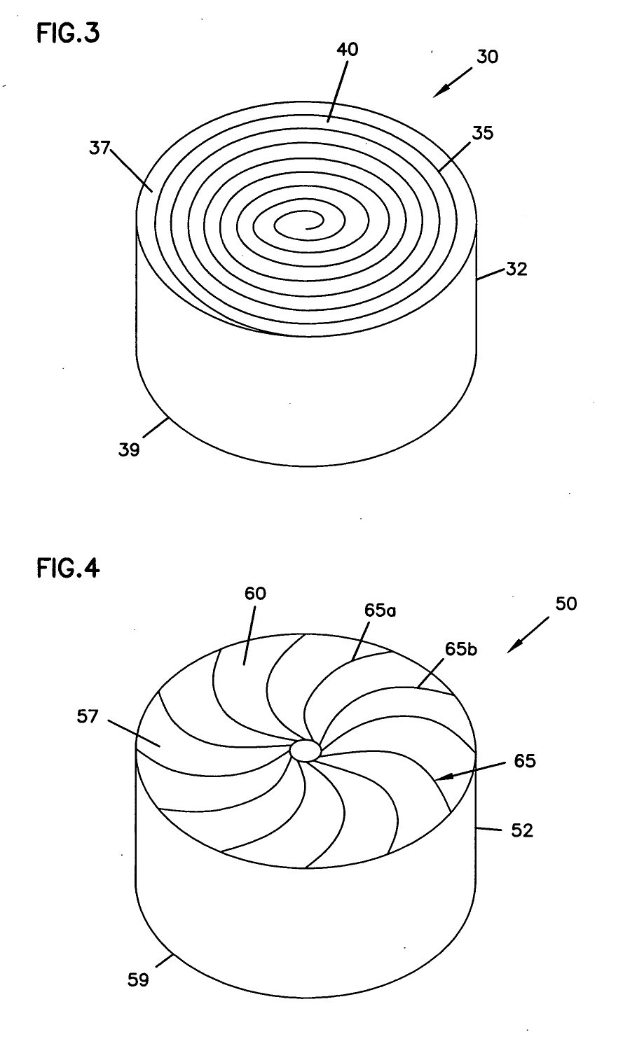

A third embodiment of a contaminant-removal filter according to the present invention is shown at 30 in FIG. 3. Contaminant-removal filter 30 is defined by a body 32 having a first face 37 and an opposite second face 39. Generally, gas to be cleansed enters filter 30 via first face 37 and exits via second face 39. The distance between first face 37 and second face 39 is the thickness of filter 30. Body 32 is formed by spiral winding a substrate layer 35. Spacers may be used to obtain the desired spacing between adjacent wraps of layer 35. The adjacent wraps of layer 35 form a passage through filter 30. Similar to filter 10′ of FIG. 2, filter 30 can have a circular or non-circular cross-section, and can include a central core to facilitate winding of the layers.

A fourth embodiment of a contaminant-removal filter according to the present invention is shown at 50 in FIG. 4. As with the previous embodiments, filter 50 is defined by a body 52 having a first face 57 and an opposite second face 59. The distance between first face 57 and second face 59 is the thickness of filter 50. Body 52 is formed by multiple individual sheets 65 of substrate arranged to form a generally spiraling configuration. For example, body 52 has a first sheet 65a, an adjacent second sheet 65b, and subsequent sheets. These sheets 65, although generally flat, may be corrugated. Adjacent sheets 65, such as 65a and 65b, together define a plurality of passages 60 through body 52 that extend from first face 57 to second face 59. As with the previous embodiments, element 50 can have a circular or non-circular cross-section and can include a core to facilitate placement of sheets 65.

Another anticipated configuration for a contaminant-removal filter according to the present invention is to have concentric layers, formed by multiple, individual sheets.

Specific features of the contaminant-removal filters are described below. For ease, although generally only the reference numerals from the first embodiment, filter 10, are used, it is understood that the description of the features applies to all embodiments, unless specifically indicated.

Body of the Filter

Body 12 provides the overall structure of contaminant-removal filter 10; body 12 defines the shape and size of filter 10. Body 12 can have any three-dimensional shape, such as a cube, cylinder, cone, truncated cone, pyramid, truncated pyramid, disk, etc., however, it is preferred that first face 17 and second face 19 have at least close to the same surface area, to allow for equal flow into passages 20 as out from passages 20. The cross-sectional shape of body 12, defined by first face 17, second face 19, or any cross-section taken between faces 17 and 19, can be any two dimensional shape, such as a square, rectangle, triangle, circle, star, oval, ellipse, racetrack, and the like. An annular shape can also be used. Preferably, the cross-section of body 12 is essentially constant along length “L” from first face 17 to second face 19.

Typically, first face 17 and second face 19 have the same area, which is at least 1 cm². Additionally or alternatively, first face 17 and second face 19 have an area that is no greater than about 1 m². In most embodiments, the area of faces 17, 19 is about 70 to 7500 cm². Specific applications for filter 10 will have preferred ranges for the area. The thickness “L” of body 12, between first face 17 and second face 19, is generally at least 0.5 cm, and generally no greater than 25 cm. In most embodiments, “L” is about 2 to 10 cm. Two particular suitable thicknesses of body 12 are 2.5 cm and 7.5 cm. The dimensions of body 12 will effect the residence time of gas in the filter and the resulting removal of contaminant from the gas stream.

Body 12 typically has a plurality of passages 20 extending therethrough; see, for example, elements 10 and 10′ of FIGS. 1 and 2. Passages 20 may have any irregular or regular shape, for example square, rectangular, triangular, circular, trapezoidal, hexagonal (e.g., “honey comb”), but a preferred shape is generally domed, such as those illustrated in FIG. 1. Preferably, the shape of passages 20 does not appreciably change from first face 17 to second face 19, and each of passages 20 within filter 10 has a similar cross-sectional shape.

Each passage 20 generally has a cross-sectional area typically no greater than about 50 mm²; this cross-sectional area is generally parallel to at least one of first face 17 and second face 19. Alternately or additionally, passages 20 typically have a cross-sectional area no less than about 1 mm². Generally the cross-sectional area of each passage 20 is about 1.5 to 30 mm², often about 2 to 4 mm². In one preferred embodiment, the cross-sectional area of a domed passage 20, such as passage 20 illustrated in FIG. 1, is about 7 to 8 mm². In another preferred embodiment, the area of passage 20 is 1.9 mm².

The longest cross-sectional dimension of passages 20 is typically no greater than 10 mm, often no greater than 6 mm. Additionally, the shortest dimension of passages 20 is no less than 0.25 mm, often no less than 1.5 mm.

The total, internal surface area of each elongate passage 20 is generally no less than about 5 mm², and is generally no greater than about 200 cm². The total surface area of filter 10, as defined by the interior surface area of passages 20, is at least about 200 cm² or about 250 cm² to 10 m².

In the third embodiment, FIG. 3, element 30 has a single passage, formed by the subsequent and adjacent winds of layer 35. In such an embodiment, the total internal surface area of element 30 is at least about 200 cm² and is usually about 250 cm² to 10 m².

The passage walls, which define the shape and size of passages 20, are defined by the substrate that forms body 12. The substrate is generally at least 0.015 mm thick. Alternately or additionally, the passage walls are generally no thicker than 5 mm. Typically, the passage walls are no greater than 2 mm thick. The thickness of the walls will vary depending on the size of passage 20, the substrate from which body 12 is made, and the intended use of filter 10. For those embodiments where layer 14 and facing layer 16 define passages 20, the passage walls are defined by layer 14 and facing layer 16.

In most embodiments, each of passages 20 has a continuous size and shape along its length. Generally, the length of each passage 20 is essentially the same as the thickness “L” between first face 17 and second face 19. It is contemplated that passage 20 is not a straight line from face 17 to face 19, however, this is generally not preferred, due to the potential of undesirable levels of pressure drop through passage 20.

Body 12 (e.g., layers 14, 16) is formed from a porous or permeable substrate; a fibrous material is a preferred material. Examples of suitable substrates for body 12 include natural (e.g., cellulosic materials) and polymeric based materials. The substrates can be nonwoven fibrous materials (such as spun-bonded), woven fibrous materials, knitted fibrous materials, or open or closed cell foam or sponge materials. Specific examples of suitable substrates include glass fiber papers, crepe papers, Kraft papers, wool, silk, cellulosic fiber fabrics (such as cotton, linen, viscose or rayon) and synthetic fiber fabrics (such as nylon, polyester, polyethylene, polypropylene, polyvinylalcohol, acrylics, polyamide and carbon fiber). Any of the substrates may be a combination of multiple materials, such as a combination of polymeric fibers with organic, inorganic or natural fibers. An example of such a material is composed of thermoplastic fibers and cellulose fibers. Additionally or alternately, the fibers themselves may be a combination of multiple materials. A resin or other binder may be used to retain fibers to form body 12. Porous ceramic materials may also be used for body 12.

The materials used should not produce deleterious off-gassing or emissions of contaminants or other materials that might affect the functioning of the reactant material present on body 12. Examples of materials that are preferably avoided include adhesives and other such materials that off-gas.

An example of a preferred substrate for body 12 has thermoplastic polymeric fibers combined with cellulose fibers. The two fibers can be homogeneously combined and formed into a sheet-like substrate. Upon heating, the polymeric fibers at least partially melt, binding the fibers together. Upon cooling, the polymeric fibers resolidify. Using such a substrate allows joining multiple sheets or layers of substrate without using an adhesive. A specific example of a substrate has about 40 wt-% polyethylene terephthalate (PET) fibers and about 60 wt-% cellulose fibers. Other combinations of thermoplastic and non-thermoplastic fibers would also be suitable.

An example of a preferred body 12, such as illustrated in FIG. 2, can be made from a corrugated sheet 14 and a facing sheet 16, both made from thermoplastic polymeric fibers combined with cellulose fibers. The sheets 14, 16 can be passed through an ultrasonic welder, which uses high frequency sound to locally heat the sheets. Pressure is applied at the areas where sheets 14, 16 contact each other, thus bonding sheets 14, 16 together.

Methods for making body 12, from a corrugated sheet 14 and a facing sheet 16 are taught, for example, are taught in U.S. Pat. No. 6,416,605 and in WO 03/47722, which are incorporated herein by reference. Body 12 is a carrier for the reactant material that removes contaminants from air or other gaseous fluid passing through filter 10.

Reactant Material

Each contaminant-removal filter 10 includes reactant material. The reactant material removes carbonyl-containing compounds from the air passing through the passages by reacting with or otherwise removing the compounds. The reactant material is preferably present throughout body 12; typically, the reactant material is impregnated, from liquid, into the substrate that forms body 12.

Examples of suitable reactant materials for use in the filter element of the invention include sulfites, bisulfites, oxidants, or derivatives of ammonia, specifically high molecular weight and stable amines. For removal of aldehydes, strong alkali (basic) materials are preferred.

More specific examples of suitable reactants include: for sulfites, sodium sulfite and potassium sulfite; for bisulfites, sodium bisulfite and potassium bisulfite; for derivatives of ammonia, specifically suitable high molecular weight and stable amines, 2,4 dinitrophenyl hydrazine (DNPH), 2-hydroxymethyl piperidine (2-HMP), and tris(hydroxymethyl)aminomethane; for strong alkali, sodium hydroxide and potassium hydroxide. Various examples of the mode of carbonyl-containing compound removal are provided below.

An example reaction of a sulfite with a carbonyl-containing compound is:
RCR′O+Na₂SO₃+H₂O→NaOH+HORCR′SO₃Na

An example reaction of a bisulfite with a carbonyl-containing compound is:
RCR′O+NaHSO₃→HORCR′SO₃Na

An example reaction of a high molecular weight and stable amine with an aldehyde is:
HCHO+NH₂—R→HCNH—R+H₂O

An example reaction of a strong alkali with an aldehyde is:
2RCHO+NaOH→RCOONa+RCH₂OH

To produce filter 10, the reactant material is provided in a liquid carrier and is impregnated into or onto the substrate that forms the contaminant-removal filter. Typically and preferably, the reactant material is impregnated into the substrate while in the form of a solution. It is understood that some materials may not dissolve in the solvent, but rather, are dispersed. Water is the preferred solvent for the solution, dispersion, or any other mixture form in which the reactant material may be.

The level of reactant material within the impregnant solution is selected based on the reactant material and the substrate being used. The amount of reactant material in the solution is at least about 0.5 wt-% and is no more than about 75 wt-%. Preferably, the amount of reactant material is 5-50 wt-%. For example, when tris(hydroxymethyl) aminomethane is used, the preferred level of is about 5 wt-% in the impregnant solution. When sodium hydroxide is used, the preferred level of is about 5 wt-%. Other levels of reactant material, such as 10-50 wt-%, would also be suitable.

Although the terms “impregnation”, “impregnate”, “impregnant”, and the like have been used, it should be understood that the method of application of the reactant material to the substrate is not limited to impregnation. Other methods may be used to provide the reactant material into the substrate. Other alternate and suitable methods for applying the reactant material into the substrate include immersion, spraying, brushing, knife coating, kiss coating, and other methods that are known for applying a liquid onto a surface or substrate. The impregnation or other application method can be done at atmospheric conditions, or under pressure or vacuum.

In a preferred method, the substrate is formed into body 12 prior to application of the reactant material. It is understood, however, that body 12 could be formed after the substrate has been formed into body 12.

After being impregnated, the substrate is at least partially dried to remove solvent (e.g., water), leaving reactant material in and on the substrate. Preferably, at least 90% of all free water or other solvent is removed, and most preferably, at least 95% of all free water or other solvent is removed.

The reactant material is present on and within at least 50% of the surface area of the passages 20 of the element. Preferably, the basic material is present on and within at least 55 to 75% of the passage wall surfaces, more preferably at least 90% of the surfaces, and most preferably, is continuous and contiguous with no areas without the reactant material. The reactant material is present through at least 10% of the thickness of the substrate. Preferably, the reactant material is present through at least 50% of the substrate, and more preferably through at least 80%.

The reactant material generally does not generally increase the thickness of the substrate. The reactant material may, however, alter the characteristics of the substrate, such as making it more rigid, brittle, or more flexible.

Additives to be Avoided

It is theorized that increased levels of moisture in the substrate decrease the suitable life of the element. Thus the use of humectants, which increase the amount of water content in the dried substrate, is undesired. Examples of humectants to be avoided include urea, glycerol, glycerin, alcohols, polyvinylpyridine, polyvinylpyrrolidone, polyvinylalcohols, polyacrylates, polyethylene glycols, and cellulosic acetates.

Regeneration

It has been found that the contaminant-removal filter of this invention can be regenerated. After use, or after a prolonged duration of non-use, the element can be again impregnated with reactant material. This second or any subsequent impregnation can be done with or without cleansing the previous contaminants from the filter; cleansing the filter could be done, for example, by a water rinse. It is foreseen that the substrate can be impregnated any number of times, any limitation being the physical intactness of the substrate.

Applications for Contaminant-Removal Filter 10

Contaminant-removal filter 10 of the present invention can be used in any variety of applications that desire the removal of carbonyl-containing compounds from a gas stream, such as an air stream. Examples of common airborne carbonyl-containing compounds include ketones, including acetone, and aldehydes, including formaldehyde.

Contaminant-removal filter 10 is particularly suitable for high purity applications that desire the removal of chemical contaminants from a gas to a level of less than 1 ppm of contaminant. In many high purity applications, the level desired is less than 1 ppb of contaminant. Filter 10 itself generally adds no contaminants, such as due to off-gassing.

Carbonyl-containing compounds, in general, are fairly malodorous and cause discomfort to many people. Some people have allergic reactions to carbonyl-containing compounds.

Generally, contaminant-removal filter 10 can be used in any application where a packed granular bed has been used; such applications include lithographic processes, semiconductor processing, photographic and thermal ablative imaging processes. Proper and efficient operation of a fuel cell would benefit from intake air that is free of unacceptable basic contaminants. Other applications where contaminant-removal filter 10 can be used include those where environmental air is cleansed for the benefit of those breathing the air. Filter 10 can be used with personal devices such as respirators (both conventional and powered) and with self-contained breathing apparatus to provide clean breathing air. Contaminant-removal filter 10 can also be used on a larger scale, for enclosed spaces such as residential and commercial spaces (such as rooms and entire buildings), airplane cabins, and automobile cabins. Filter 10 can also be used to protect engine or power generating equipment that use an air intake source for the combustion process. At other times, it is desired to remove contaminants prior to discharging the air into the atmosphere; examples of such applications include automobile or other vehicle emissions, exhaust from industrial operations, gas turbines or any other operation or application where chemical contaminants can escape into the environment.

Filter 10 is typically positioned in a housing, frame or other type of structure that directs gas flow (e.g., air flow) into and through passages 20 of filter 10. In many configurations, filter 10 is at least partially surrounded around its perimeter by a housing, frame or other structure.

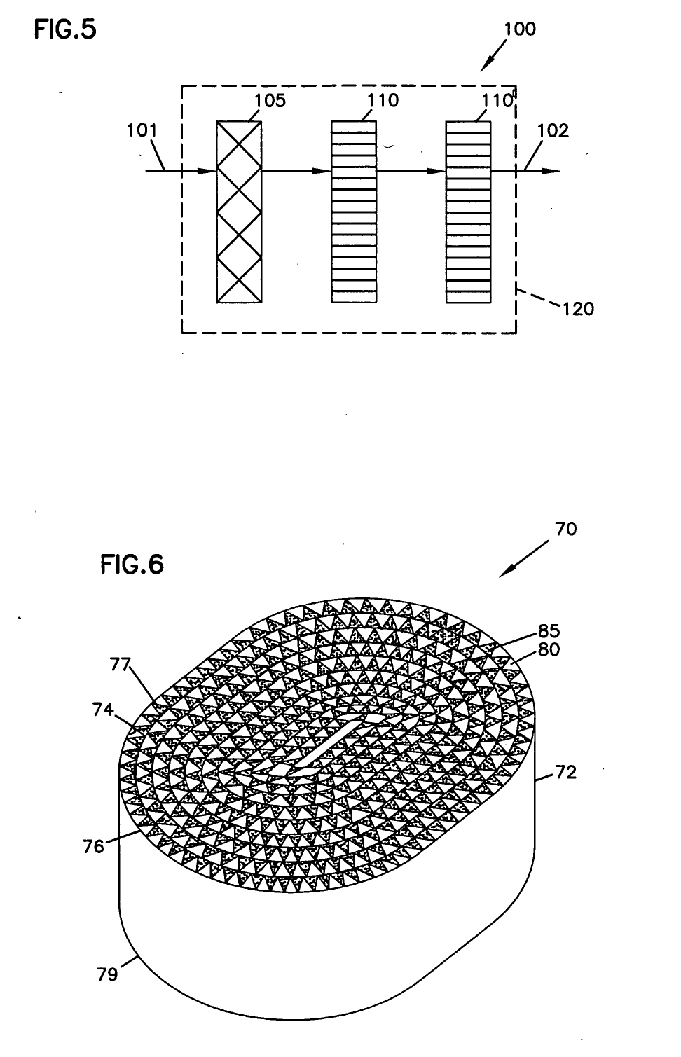

When a contaminant-removal filter 10, made by any process described herein, is positioned within a system, a pre-filter, a post-filter, or both may be used in conjunction with contaminant-removal filter 10. A pre-filter is positioned upstream of filter 10 to remove airborne particles prior to engaging filter 10. A post-filter is positioned downstream of filter 10 to remove residual particles from filter 10 before the air is released. These filters are generally placed against or in close proximity to first face 17 and second face 19, respectively, of contaminant-removal filter 10. An example of a system including a pre-filter is illustrated in FIG. 5.

In FIG. 5, a system 100 is illustrated for removing contaminants from a dirty gas stream 101. System 100 includes a particulate filter 105, a first contaminant-removal filter 110, and a second contaminant-removal filter 110′. Particulate filter 105 is configured to remove solid particles, such as dust and smoke, from gas stream 101. Typically, if particulate filter 105 is used, particulate filter 105 is positioned upstream of contaminant-removal filters 110 and 110′, to decrease the potential of filters 110, 110′ being clogged or laden with particulate. First contaminant-removal filter 110 is configured to remove carbonyl-containing compounds from gas stream 101. Second contaminant-removal filter 110′ may be configured to remove, for example, acidic or basic contaminants from gas stream 101. Examples of suitable contaminant-removal filters 110′ to remove basic contaminants are described in U.S. patent application having Serial No. 10/928,776, and examples of suitable contaminant-removal filters 110′ to remove acidic contaminants are described in U.S. patent application having Serial No. 10/927,708. It is understood that in alternate embodiments, filters 110, 110′ can be configured to remove acidic or basic contaminants and then carbonyl contaminants. After passing through each of particulate filter 105, contaminant-removal filter 110, and contaminant-removal filter 110′, the resulting cleaned gas stream is designated as 102.

Any or all of particulate filter 105, filter 110, and filter 110′ may be retained in a housing, such as housing 120. Filters 105,110, 110′ may be positioned adjacent one another, or may have spacing therebetween.

An alternate configuration for a combined carbonyl-removal filter and particulate filter is illustrated in FIG. 6 as filter 70. Contaminant-removal filter 70 is defined by a body 72 having a first face 77 and an opposite second face 79. Generally, gas to be cleansed enters filter 70 via first face 77 and exits via second face 79. Body 72 is similar to body 12 of filter 10′ of FIG. 2, having alternating corrugated layer 74 and facing layer 76. Layer 74 and layer 76 together define a plurality of passages 80. A first set of passages 80 are blocked or sealed at first face 79; these are illustrated as seals 85. At the opposite end of seals 85, at second face 79, passages 80 are open. Additionally, a second set of passages 80 are blocked or sealed at the second face 79 and are open at the first face 79.

In use, particulate laden gas enters open passage 80 at first face 79. The particulates become trapped in passages 80 due to the sealed second face 79, whereas the gas passes through the passage walls, formed by the fibrous substrate. The reactant material in and on the substrate removes carbonyl-containing compounds. The cleaned gas exits via second face 79.

Filter 70 is commonly referred to as a z-filter, a straight-through flow filter, or an in-line filter. The particulate removal features of such a filter as filter 70 are disclosed, for example, in U.S. Pat. Nos. 5,820,646; 6,190,432; 6,350,291.

Positioned downstream of filter 10 or any of the other embodiments of the filter can be an indicator or indicating system to monitor the amount, if any, of contaminant that is passing through filter 10 without being removed. Such indicators are well known. The indicator can also be incorporated as part of the filter substrate by either coating a portion of the filter substrate with an indicating solution, or placing an indicating section of the filter media downstream of the main filter section.

The shape and size of filter 10 is selected to remove the desired amount of contaminants from the gas or air passing therethrough, based on the residence time of the gas in filter 10. For example, preferably at least 90%, more preferably at least 95% of carbonyl-containing compounds are removed. In some designs, as much as 98%, or more, of the compounds are removed. It is understood that the desired amount of contaminants to be removed will differ depending on the application and the amount and type of contaminant.

### EXAMPLES

The following non-limiting examples will further illustrate the invention. All parts, percentages, ratios, etc., in the examples are by weight unless otherwise indicated.

The following substrate body was used for the example contaminant-removal elements:

Body 1: Body 1 was similar to that of FIG. 2, formed by alternating a flat facing sheet and a sinusoidal corrugated sheet. The sheets were made from 60% cellulose fibers and 40% PET fibers. The sheets were wrapped to form a cylinder. The resulting domed passages had an approximate height of 1.05 mm and width of 2.90 mm. The cross-sectional area of each passage was about 1.5 mm². The sheets were held together by the thermoplastic material from the sheets, which had been melted with heat created by ultrasonic energy, and then had cooled.

For filter elements according to the invention, the bodies were impregnated with reactant material by the following method. A volume of reactant solution was placed in a beaker. The fibrous body was placed into the beaker, so that entire body was immersed in the solution. After approximately 60 seconds, the body was removed and allowed to dry in an oven for 1 hour.

After drying, the resulting filter element was tested to determine its estimated life.

Breakthrough Test

For the Breakthrough Test, the filter element was placed in a test chamber and sealed to provide an upstream side of the filter and a downstream side. An air stream that contained 0.7 ppm formaldehyde and 50% relative humidity was delivered to the upstream side of a filter element at a flow rate of 30 liters/minute. The filter element had a diameter of about 3.8 cm and a length of about 2.54 cm. The downstream formaldehyde concentrations were monitored using a detector.

### Comparative Example A

A filter element was made from Body 1, having a diameter of about 3.8 cm and a length of about 2.54 cm. There was no surface or substrate treatment of the body substrate.

### Example 1

A solution of 5% tris(hydroxymethyl)aminomethane in water was made. Body 1, having a diameter of about 3.8 cm and a length of about 2.54 cm, was impregnated with the solution.

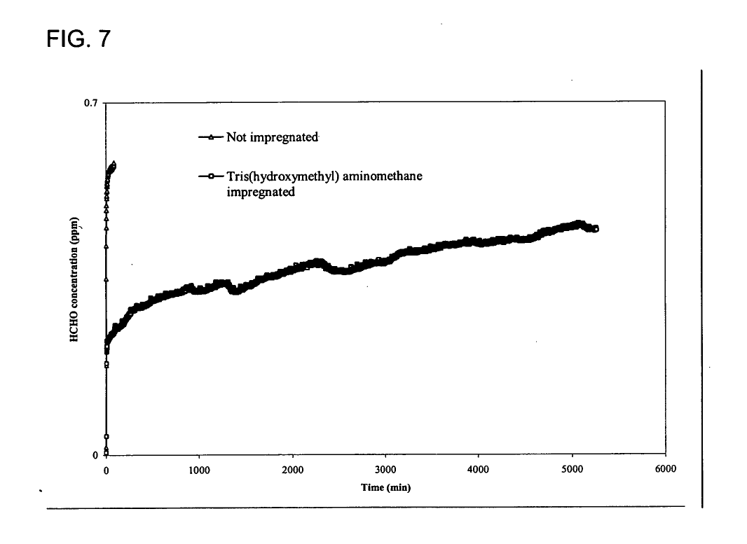

Example 1 and Comparative Example A were tested according to the Breakthrough Test, and the results are shown in FIG. 7. The graph of FIG. 7 illustrates that the impregnated filter element, Example 1, had a drastically extended life. The formaldehyde levels reached 0.5 ppm for Comparative Example A almost immediately, whereas Example 1 had at least 5000 minutes before 0.5 ppm formaldehyde was reached.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed:

1. A contaminant-removal filter comprising:
a body comprising a fibrous substrate, and reactant material throughout the substrate, the reactant being selected from the group of sulfites, bisulfites, derivatives of ammonia, specifically high molecular weight and stable amines, and strong alkali.

2. The filter according to claim 1, wherein the derivative of ammonia is one of 2,4 dinitrophenyl hydrazine (DNPH), 2-hydroxymethyl piperidine (2-HMP), and tris(hydroxymethyl)aminomethane.

3. The filter according to claim 2, wherein the derivative of ammonia is tris(hydroxymethyl)aminomethane.

4. The filter according to claim 1, where in the sulfite is sodium sulfite or potassium sulfite.

5. The filter according to claim 1, where in the bisulfite is sodium bisulfite or potassium bisulfite.

6. The filter according to claim 1, wherein the fibrous substrate has a first face and a second face, and a plurality of passages extending from the first face to the second face.

7. The filter according to claim 1, wherein the fibrous substrate comprises thermoplastic and cellulosic fibers.

8. The filter according to claim 1 being free of any humectant.

9. A method of making a carbonyl-containing compound-removal filter, the method comprising:
(a) providing a substrate;
(b) applying a mixture comprising a reactant selected from the group of sulfites, bisulfites, derivatives of ammonia, specifically high molecular weight and stable amines to the substrate.

10. The method of claim 9, wherein the step of applying a mixture comprising reactant to the substrate comprises:
(a) applying a mixture comprising one of 2,4 dinitrophenyl hydrazine (DNPH), 2-hydroxymethyl piperidine (2-HMP), and tris(hydroxymethyl)aminomethane.

11. The method of claim 9, wherein the step of applying a mixture comprises reactant to the substrate comprises:
(a) applying a mixture comprising 0.5 to 75 wt-% reactant.

12. The method of claim 11, wherein the step of applying a mixture comprises reactant to the substrate comprises:
(a) applying a mixture comprising 5 to 50 wt-% reactant.
